(19) United States
(12) Patent Application Publication
(10) Pub. No.: US 2007/0101330 A1
(43) Pub. Date: May 3, 2007

(54) DATA PROCESSING APPARATUS AND METHOD

(75) Inventor: Eiji Aizawa, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/539,853

(22) Filed: Oct. 9, 2006

(30) Foreign Application Priority Data
Oct. 27, 2005 (JP) 2005-313096

(51) Int. Cl. G06F 9/46

(52) U.S. Cl. 718/100

(57) ABSTRACT

A data processing apparatus includes a logic circuit, a processor, and a holding unit. While executing a first task, the logic circuit requests the processor to execute processing. The logic circuit executes a second task while the processor is executing the requested processing. After the processor issues a result of the processing, the logic circuit receives task information on the first task from the holding unit and executes the first task.

### BACKGROUND OF THE INVENTION

1. Field of the Invention

The present invention relates to a data processing apparatus including a logic circuit and a processor, and to a data processing method for use in the logic circuit.

2. Description of the Related Art

In recent years, due to an increase in the scale of LSI (large-scale integrated circuit) development, reuse of design assets has been implemented. In such a situation, design assets with high performance, high functionality, and capability to expand functions have been highly required. In addition, in place of design assets whose entire configuration is constituted by hardware, hardware-software-cooperation data processing apparatuses including not only hardware but also software constituted by software executed by a processor have been developed.

Generally, in hardware-software-cooperation data processing apparatuses, processing to be frequently performed, processing requiring high-speed performance, and the like are often performed by a hardware portion, and processing not to be frequently performed, processing for maintaining downward compatibility, and the like are often performed by a software portion. Accordingly, hardware-software-cooperation data processing apparatuses achieve high performance, high functionality, and high expandability.

In addition, as described in US Patent Application Publication No. 2004/0187122, a technology for achieving more efficient thread scheduling of software is available.

Here, a case where task processing that requires synchronous processing between hardware and software is performed in hardware-software-cooperation data processing is considered. Normally, software processing (processor processing) is superior to hardware processing in terms of flexibility and expandability. However, software processing requires a considerably long processing time. Thus, in a case where a task that requires synchronous processing is subjected to software processing in a hardware-software-cooperation data processing apparatus, when the software processing is performed, hardware processing enters a wait state and stalls in order to achieve synchronization until the software processing is terminated. Thus, in a hardware-software-cooperation data processing apparatus, due to insufficient realization of the performance of hardware, the throughput may be reduced, and required system performance may not be satisfied.

### SUMMARY OF THE INVENTION

In light of the aforementioned disadvantages, according to an aspect of the present invention, the throughput of hardware-software-cooperation data processing is improved. In addition, according to another aspect of the present invention, the wait time of a logic circuit is reduced while a processor is executing processing requested by the logic circuit.

According to an aspect of the present invention, a data processing apparatus is provided which includes a logic circuit and a processor. The data processing apparatus includes a holding unit configured to hold task information that is being executed by the logic circuit, wherein, while executing a first task, the logic circuit requests the processor to execute processing, wherein the logic circuit executes a second task while the processor is executing the requested processing, and wherein, after the processor issues a result of the processing, the logic circuit receives from the holding unit task information on the first task and executes the first task.

According to another aspect of the present invention, while the processor is executing the requested processing, the logic circuit interrupts the first task and executes the second task. Moreover, according to another aspect of the present invention, after the processor issues the result of the processing, the logic circuit interrupts the second task, receives from the holding unit the task information on the first task, and executes the first task.

Furthermore, according to yet another aspect of the present invention, after terminating the first task, the logic circuit receives from the holding unit task information on the second task and resumes the second task. Additionally, according to another aspect of the present invention, the logic circuit may have a pipeline structure. Moreover, according to another aspect of the present invention, the logic circuit executes image forming processing.

According to still yet another aspect of the present invention, the apparatus may further include a comparing unit configured to compare priority levels of tasks, wherein, when a priority level of the first task is higher than a priority level of the second task, after the processor issues the result of the processing, the logic circuit receives from the holding unit the task information on the first task and executes the first task.

Furthermore, according to still yet another aspect of the present invention, a data processing method is provided for use in a logic circuit. Here, the method includes saving task information on a first task when a processor is requested to execute processing while the first task is being executed; executing a second task while the processor is executing the requested processing; and restoring the saved task information on the first task in order to execute the first task after the processor issues a result of the processing.

According to another aspect of the present invention, while the processor is executing the requested processing, the first task is interrupted, and the second task is executed. Still further, according to another aspect of the present invention, after the processor issues the result of the processing, the second task is interrupted, and the saved task information on the first task is restored in order to execute the first task.

Moreover, according to another aspect of the present invention, the method may also include saving task information on the interrupted second task; and restoring the saved task information on the second task in order to resume the second task after the first task is terminated. Also, according to yet another aspect of the present invention, the method may also include comparing priority levels of tasks, when a priority level of the first task is higher than a priority level of the second task, after the processor issues the result of the processing, the saved task information on the first task is restored in order to execute the first task.

Furthermore, according to another aspect of the present invention, a computer readable medium is provided containing computer-executable instructions for processing data in a logic circuit. Here, the medium includes computer-executable instructions for saving task information on a first task when a processor is requested to execute processing while the first task is being executed; computer-executable instructions for executing a second task while the processor is executing the requested processing; and computer-executable instructions for restoring the saved task information on the first task in order to execute the first task after the processor issues a result of the processing.

Further features and aspects of the present invention will become apparent from the following description of exemplary embodiments with reference to the attached drawings.

### BRIEF DESCRIPTION OF THE DRAWINGS

FIG. 1 is a block diagram showing an example of a configuration of an image forming apparatus according to an aspect of the present invention.

FIG. 2 is a block diagram showing an example of a functional configuration for image formation performed by an image forming unit according to an aspect of the present invention.

FIG. 3 is an illustration for explaining an example flow of image formation using the image forming apparatus according to an aspect of the present invention.

FIG. 4 is a schematic diagram showing an example of the configuration of a context information holding unit according to an aspect of the present invention.

FIG. 5 is an illustration for explaining a processing time when context switch is not performed according to an aspect of the present invention.

FIG. 6 is an illustration for explaining a processing time when context switch is performed according to an aspect of the present invention.

### DESCRIPTION OF THE EMBODIMENTS

Embodiments, features and aspects of the present invention will now be herein described with reference to the drawings.

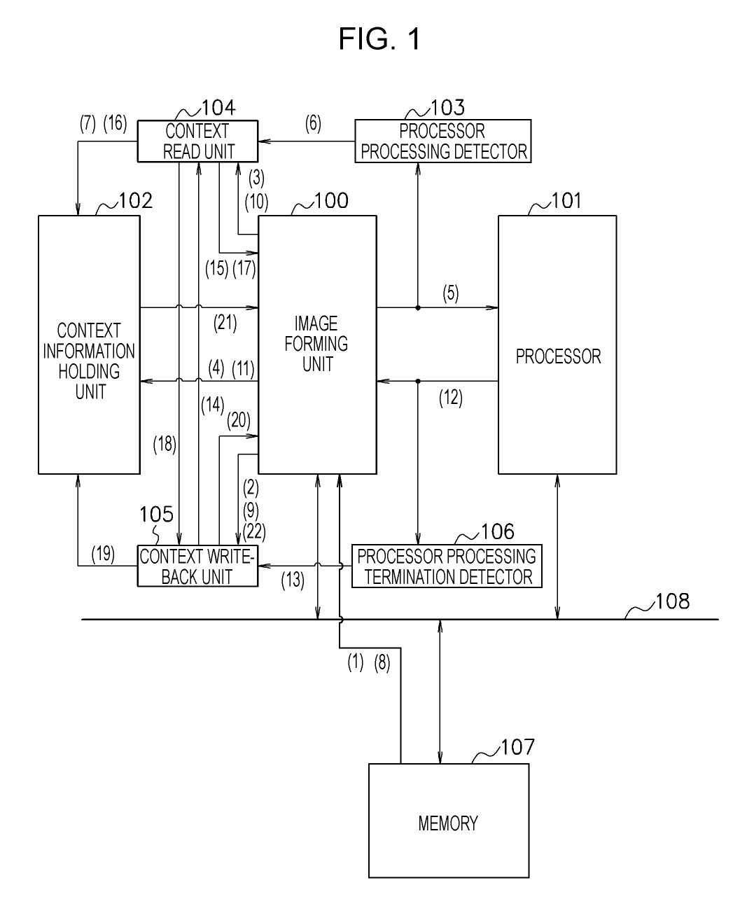

FIG. 1 is a block diagram showing an example of a configuration of an image forming apparatus, which is an example of a data processing apparatus according to an aspect of the present invention.

Referring to FIG. 1, the image forming apparatus according to this exemplary embodiment includes an image forming unit 100, a processor 101, and a context information holding unit 102. The image forming apparatus also includes a processor processing detector 103, a context read unit 104, a context write-back unit 105, a processor processing termination detector 106, and a memory 107. The image forming unit 100, the processor 101, and the memory 107 are connected to each other via a bus 108 so as to be able to communicate with each other.

The image forming unit 100 is constituted by a logic circuit (hardware). The image forming unit 100 reads a display list from the memory 107. In addition, the image forming unit 100 adds an ID to the read display list, and informs the context write-back unit 105 of generation of the new display list ID. The ID may be generated by the image forming unit 100 or may be generated by software that controls the image forming unit 100.

The image forming unit 100 performs processing in accordance with an instruction described in the read display list. When detecting an instruction that cannot be processed in the display list, the image forming unit 100 requests the processor 101 to perform the processing. In addition, after the processor 101 terminates the processing, the image forming unit 100 receives a result of the processing. In addition, the image forming unit 100 supplies to the context read unit 104 and the context write-back unit 105 the display list ID that is being executed by the image forming unit 100.

The image forming unit 100 stops processing in accordance with a processing stop signal issued by the context read unit 104, invalidates information in accordance with a processing invalidation signal, and supplies to the context information holding unit 102 context information on the display list that is being executed. Information invalidated in accordance with a processing invalidation signal affects a processing result stored in the image forming unit 100.

In accordance with an instruction from the context write-back unit 105, the image forming unit 100 receives context information on a display list stored in the context information holding unit 102. Then, the image forming unit 100 sets the received context information into an internal register as context information on a display list to be executed. After display list processing is terminated, the image forming unit 100 deletes the display list ID added to the display list, and informs the context write-back unit 105 of the deleted display list ID.

The processor 101 receives a processing request from the image forming unit 100, and analyzes the processing contents. On the basis of an analysis result, the processor 101 acquires necessary data from the memory 107 and performs processing. The processing (processor processing) by the processor 101 is realized when the processor 101 executes a program (software) for the corresponding processing. After completing the processing corresponding to the processing request, the processor 101 issues a processing result to the image forming unit 100.

The context information holding unit 102 stores context information, which is task information on a task that is being executed, supplied from the image forming unit 100. In accordance with a write control signal supplied from the context read unit 104, the context information holding unit 102 stores therein the context information on a display list that is being executed supplied from the image forming unit 100. In addition, in accordance with a read control signal supplied from the context write-back unit 105, the context information holding unit 102 supplies to the image forming unit 100 the context information that is stored in the context information holding unit 102.

The processor processing detector 103 detects that the image forming unit 100 has requested the processor 101 to perform processing. The processor processing detector 103 monitors whether or not a signal line used for transferring processing from the image forming unit 100 to the processor 101 changes. When detecting transfer of processing, the processor processing detector 103 informs the context read unit 104 that a processing request has been issued to the processor 101.

The context read unit 104 generates a signal for designating a place in which context information supplied from the image forming unit 100 to the context information holding unit 102 is to be stored. The context read unit 104 receives from the image forming unit 100 a display list ID that is being executed. In addition, the context read unit 104 receives from the processor processing detector 103 a signal indicating that a processing request has been issued to the processor 101.

The context read unit 104 receives from the context write-back unit 105 a context read instruction signal. In a case where the context read unit 104 receives the context read instruction signal, after reading of context information is completed, the context read unit 104 issues a context read termination signal to the context write-back unit 105.

In addition, the context read unit 104 issues to the image forming unit 100 a processing stop signal for instructing stopping of processing and a processing invalidation signal for instructing invalidation of processing. In addition, the context read unit 104 issues to the context information holding unit 102 a signal for designating a place in which context information supplied from the image forming unit 100 to the context information holding unit 102 is to be stored.

The context write-back unit 105 controls writing back of context information from the context information holding unit 102 to the image forming unit 100. The context write-back unit 105 receives from the image forming unit 100 a new display list ID, a terminated display list ID, and a display list ID that is being executed, and specifies the priority order of the display lists.

The context write-back unit 105 receives from the processor processing termination detector 106 a display list ID for which processor processing is terminated, and compares the priority level of the display list that is being executed by the image forming unit 100 with the priority level of the display list for which processing by the processor 101 is terminated. If the priority level of the display list for which processing by the processor 101 is terminated is higher, the context write-back unit 105 issues to the context read unit 104 a context read instruction signal. After receiving a context read termination signal from the context read unit 104, the context write-back unit 105 issues to the image forming unit 100 a context write-back instruction signal, and issues to the context information holding unit 102 a signal designating context information to be read.

The processor processing termination detector 106 detects that a processing result is issued from the processor 101 to the image forming unit 100. The processor processing termination detector 106 monitors a signal between the processor 101 and the image forming unit 100. When detecting that processing by the processor 101 is terminated in accordance with an issued processing result, the processor processing termination detector 106 issues to the context write-back unit 105 a display list ID added to the processing result. The memory 107 stores therein a display list to be processed, data necessary for processing, and a processing result.

In the explanation given above, the processor processing detector 103 and the processor processing termination detector 106 detect issue of a processing request and termination of the processing in accordance with signals exchanged via a signal line between the image forming unit 100 and the processor 101. However, the present invention is not limited to this. The processor processing detector 103 and the processor processing termination detector 106 may implement a program (software) to be executed by the processor 101 so that issue of a processing request and termination of the processing can be detected.

The image forming unit 100 processes a display list acquired by object graphic description to generate a pixel. In the display list, drawing objects included within the original object graphic description are sorted into an ascending order in a sub-scanning line direction (y-coordinate) and are recorded. In addition, the display list includes, as an edge table, edge information on each object and, as a level table, the relationship (an arithmetic method) between level information associated with each edge and a pixel at the same coordinates at another level. In addition, the display list includes, as a fill table, information for determining the color inside an object. As information for determining the color of an object, data and processing for generating color are designated. In some cases, as information for determining the color of an object, performing reading of a bitmap or decompression of a compressed image and fetching a desired pixel from the result may be designated.

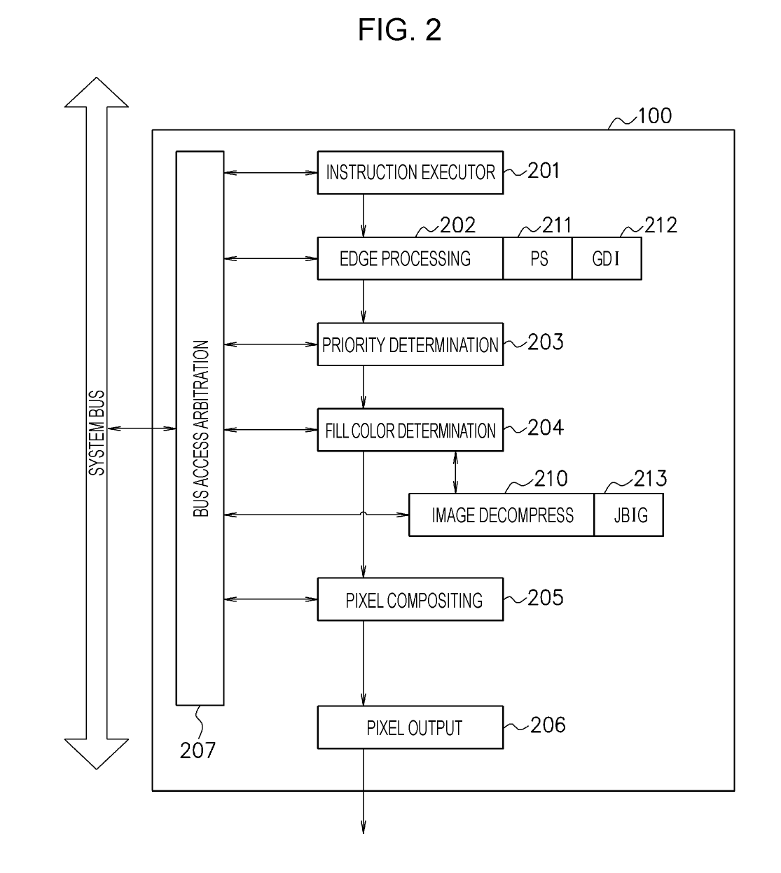

FIG. 2 is a block diagram showing an example of a functional configuration for image formation performed by the image forming unit 100.

Referring to FIG. 2, the image forming unit 100 includes modules 201 to 207 and modules 210 to 213, which will be described later. The image forming unit 100 has a pipeline structure. The modules 201 to 206 are also called “pipeline modules”.

An instruction executor 201 accesses a system bus to read a display list. The instruction executor 201 interprets an instruction stream within the read display list, and issues an internal command to the pipeline modules 202 to 205.

In accordance with the internal command issued by the instruction executor 201, an edge processing unit 202 reads edge information included in the display list, and extracts edge information on a drawing object for each scanning line. After sorting the extracted edge information into an ascending order in a scanning line direction (x-coordinate), the edge processing unit 202 transfers to a level priority determination unit 203, which is disposed in the subsequent stage in the pipeline structure, the edge information as a message.

In accordance with the internal command issued by the instruction executor 201, the level priority determination unit 203 reads a level table included in the display list and edge information generated by the edge processing unit 202. The level priority determination unit 203 determines, in accordance with the read level table and edge information, the priority of each level and an activated pixel range (that affects drawing) for each scanning line. In addition, the level priority determination unit 203 sorts, on the basis of the priority order, information on the activated pixel range for each scanning line. The level priority determination unit 203 transfers to a fill color data determination unit 204, which is disposed in the subsequent stage in the pipeline structure, pixel range information constituted by the sorted information on the activated pixel range and information on the relationship with a pixel at another level.

In accordance with the internal command issued by the instruction executor 201, the fill color data determination unit 204 reads a fill table included in the display list and the pixel range information generated by the level priority determination unit 203, and determines the color of an activated pixel for each level on the basis of the read fill table and pixel range information. The fill color data determination unit 204 transfers to a pixel compositing unit 205, which is disposed in the subsequent state in the pipeline structure, color information on the activated pixel together with the pixel range information transferred from the level priority determination unit 203.

The pixel compositing unit 205 generates the final color of a pixel in accordance with the internal command issued by the instruction executor 201. The pixel compositing unit 205 generates the final color of the pixel by executing an arithmetic operation for determining color for each pixel in accordance with the pixel range information at each level generated by the level priority determination unit 203 and the color information on the pixel determined by the fill color data determination unit 204.

A pixel output unit 206 outputs to a connected external apparatus the pixel generated by the pixel compositing unit 205. A bus access arbitration unit 207 performs arbitration and sequencing for access to the system bus from the edge processing unit 202, the level priority determination unit 203, the fill color data determination unit 204, and the pixel compositing unit 205, and relays the access to the system bus.

In the image forming unit 100, an extension unit may be added to each of the edge processing unit 202, the level priority determination unit 203, the fill color data determination unit 204, and the pixel compositing unit 205 in accordance with performance and cost required for the system. In addition, an image decompressor 210 may be added to the fill color data determination unit 204, and an extension unit may be added to the image decompressor 210.

In the example shown in FIG. 2, the image decompressor 210 is added to the fill color data determination unit 204, extension units (edge processing extension units) 211 and 212 are added to the edge processing unit 202, and an extension unit (image decompression extension unit) 213 is added to the image decompressor 210.

The image decompressor 210 is an extender module that supports, for example, Joint Photographic Experts Group (JPEG), which is capable of handling a compressed image when the color of a pixel is determined. The edge processing extension unit 211 is an extender module corresponding to PostScript (PS), and the edge processing extension unit 212 is an extender module corresponding to Graphics Device Interface (GDI). The image decompression extension unit 213 is an extender module corresponding to Joint Bi-level Image experts Group (JBIG).

When an internal command requiring a function that is not provided in the edge processing unit 202, the level priority determination unit 203, the fill color data determination unit 204, or the pixel compositing unit 205 is issued by the instruction executor 201, the image forming unit 100 is capable of requesting the processor 101 to perform processing. For example, the edge processing unit 202 has, as a basic function, a processing function for a linear segment. In this case, although the edge processing unit 202 has processing functions of the edge processing extension modules 211 and 212, the edge processing unit 202 does not have a processing function for a spline curve, such as a Bezier curve. When the instruction executor 201 detects an instruction requiring processing for a Bezier curve in a display list, the instruction executor 201 issues to the edge processing unit 202 an internal command for processing the Bezier curve. When receiving the internal command, the edge processing unit 202 requests the processor 101 to perform the processing for the Bezier curve. After receiving an execution result from the processor 101, the edge processing unit 202 performs processing for the next edge.

Although the edge processing unit 202 has been explained as an example, the level priority determination unit 203, the fill color data determination unit 204, or the pixel compositing unit 205 is capable of requesting the processor 101 to perform processing using a function that is not provided in the level priority determination unit 203, the fill color data determination unit 204, or the pixel compositing unit 205.

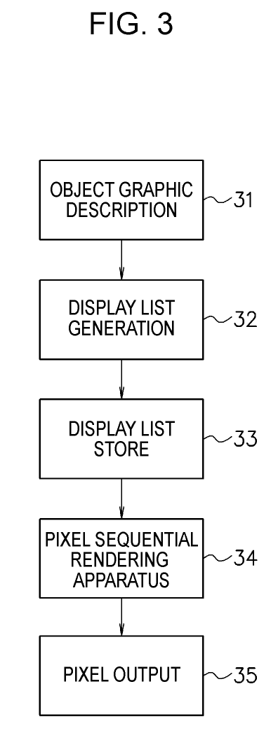

FIG. 3 is an illustration for explaining the flow of image formation using the image forming apparatus according to this embodiment.

Referring to the example image formation flow shown in FIG. 3, object graphic description 31 is first performed. Object graphic description 31 is generated by a host processor or supplied from a system memory. In object graphic description 31, a parameter of a graphic object is described. For example, an object including edges in a plurality of formats may be incorporated into object graphic description 31. One of the plurality of formats may be a linear edge (simple vector) that traverses from a point to another point on a display or an orthogonal edge format in which a two-dimensional object is defined by a plurality of edges including orthogonal lines. Apart from them, a format in which an object is defined by a continuous curve can also be adopted. Such formats may include a segment of a quadratic polynomial in which a single curve can be described using some parameters so that image formation of a quadratic curve is achieved within a single output space without performing multiplication. In addition, other data formats, such as a cubic spline curve or a similar format, may be used. An object may include a mixture of many different types of edges. Normally, identifiers of a start point and an end point of each line (irrespective of a linear line or a curve) are common in all the formats, and each of the start point and the end point is identified by a scan line number and defines a particular output space in which image formation of a curve can be achieved.

Then, data necessary for description of a graphic object to be subjected to image formation is identified, and display list generation 32 is performed. It is preferable that display list generation 32 be performed as a software module executed by a host processor. In display list generation 32, object graphic description represented by one or more than one of a well-known graphic description language, graphic library call, and other application inherent formats is converted into a display list.

The acquired display list is normally written to display list store 33. In general, display list store 33 is formed within a random-access memory (RAM). However, instead of being formed within the RAM, display list store 33 may be formed within the memory 107 that is locally provided in a pixel sequential rendering apparatus 34 (see FIG. 1). In display list store 33, a plurality of components may be included. One of the plurality of components is an instruction stream, and another one of the plurality of components is edge information, thus capable of including raster image pixel data. The instruction stream includes an interpretable code as an instruction to be read by the pixel sequential rendering apparatus 34 in order to perform image formation of a particular graphic object desired within a particular image.

Display list store 33 is read by the pixel sequential rendering apparatus 34 (see FIG. 1). The image forming apparatus 34 converts the display list into a stream of raster pixels. In pixel output 35, the stream can be transferred to another apparatus, such as a printer, a display, or a memory store.

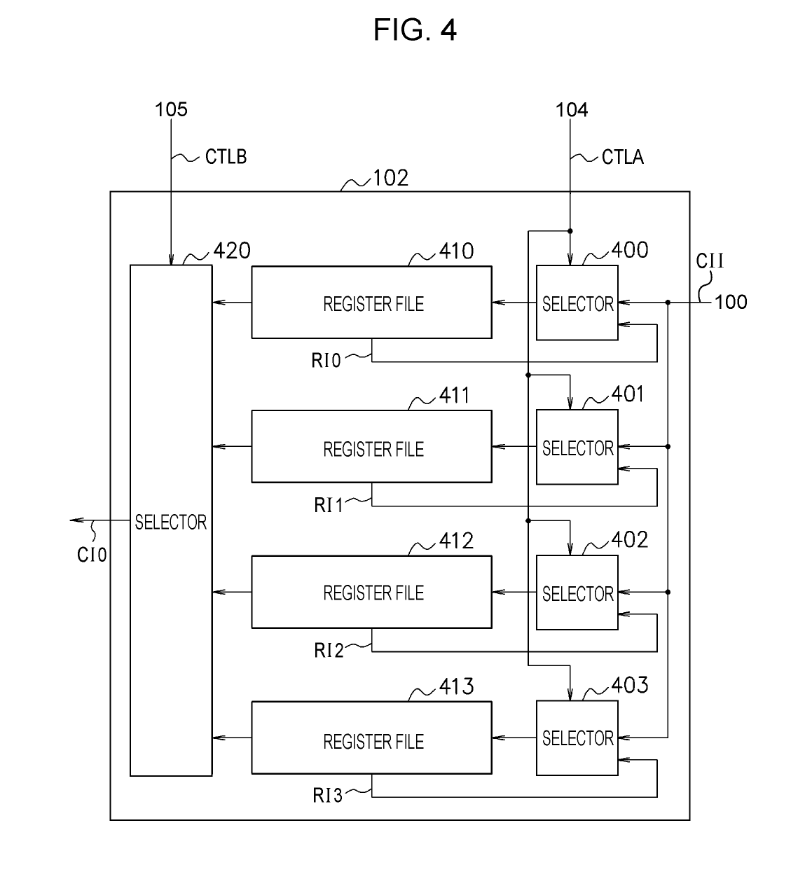

FIG. 4 is a schematic diagram showing an example of a configuration of the context information holding unit 102 according to this embodiment.

Referring to FIG. 4, a selector 400 is provided for an input context for a display list ID “0”. The selector 400 selects and outputs context information CII supplied from the image forming unit 100 or information RI0 on a register file 410 in accordance with a control signal CTLA issued from the context read unit 104. The register file 410 holds context information for the display list ID “0” (not shown) selected by the selector 400.

A selector 401 is provided for an input context for a display list ID “1” (not shown). The selector 401 selects and outputs context information CII supplied from the image forming unit 100 or information RI1 on a register file 411 in accordance with a control signal CTLA issued from the context read unit 104. The register file 411 holds context information for the display list ID “1” selected by the selector 401.

A selector 402 is provided for an input context for a display list ID “2” (not shown). The selector 402 selects and outputs context information CII supplied from the image forming unit 100 or information RI2 on a register file 412 in accordance with a control signal CTLA issued from the context read unit 104. The register file 412 holds context information for the display list ID “2” selected by the selector 402.

A selector 403 is provided for an input context for a display list ID “3” (not shown). The selector 403 selects and outputs context information CII supplied from the image forming unit 100 or information RI3 on a register file 413 in accordance with a control signal CTLA issued from the context read unit 104. The register file 413 holds context information for the display list ID “3” selected by the selector 403.

A selector 420 is provided to output context information CIO. The selector 420 selects one of the register files 410, 411, 412, and 413 in accordance with a control signal CTLB issued from the context write-back unit 105, and issues to the image forming unit 100 context information stored in the selected register file 410, 411, 412, or 413.

Although the context information holding unit 102 that is capable of handling four display list IDs is shown as an example in FIG. 4, the present invention is not limited to this. Any number of display list IDs can be provided. The context information holding unit 102 can include any number of selectors for input contexts and any number of register files in accordance with the desired number of display list IDs.

An example operation of the image forming apparatus according to this embodiment is described next. In the description given below, a case where at most four display list IDs can be provided will be explained. For the sake of easier explanation, a switching operation between two display lists will be explained.

Referring back to FIG. 1, the image forming unit 100 reads a display list from the memory 107 via the bus 108 (1). In addition, the image forming unit 100 adds, as an ID by which each display list can be uniquely identified, a display list ID “0” to the read display list. Then, the image forming unit 100 informs the context write-back unit 105 of the added new display list ID (2), and performs processing in accordance with an instruction described in the display list.

The image forming unit 100 constantly supplies to the context read unit 104 and the context write-back unit 105 the display list ID “0” of the display list that is being executed inside the image forming unit 100 ((3) and (2)). The image forming unit 100 also constantly supplies to the context information holding unit 102 context information on the display list that is being executed (4). When detecting an instruction that cannot be processed by the image forming unit 100 in the display list that is being executed, the image forming unit 100 issues to the processor 101 a processing request including the display list ID “0” (5), and interrupts the processing on the display list.

When detecting that the image forming unit 100 has requested the processor 101 to perform the processing, the processor processing detector 103 informs the context read unit 104 that a processing request has been issued to the processor 101 (6). When receiving the report (signal) from the processor processing detector 103, the context read unit 104 outputs to the context information holding unit 102 a signal (CTLA) instructing storing of the context information on the display list ID “0” that is being executed by the image forming unit 100 (7).

When the instruction to store the context information on the display list ID “0” is given by the context read unit 104, the context information holding unit 102 stores into the register file 410 the context information that is constantly supplied from the image forming unit 100.

After interrupting the processing on the display list of the display list ID “0”, the image forming unit 100 confirms that the register files 411 to 413 are not used, and reads a new display list from the memory 107 (8). The image forming unit 100 adds a display list ID “1” to the read display list, and informs the context write-back unit 105 of the added new display list ID “1” (9). The image forming unit 100 performs processing in accordance with an instruction described in the display list to which the display list ID “1” is added. Here, the image forming unit 100 constantly supplies to the context read unit 104 and the context write-back unit 105 the display list ID “1” of the display list that is being executed inside the image forming unit 100 ((10) and (9)). The image forming unit 100 also constantly supplies to the context information holding unit 102 context information on the display list (11).

When the image forming unit 100 generates a new display list ID as described above, the context write-back unit 105 receives a report about the new display list ID from the image forming unit 100, and manages the display list ID inside the context write-back unit 105 in order to specify the priority order of display lists. Management of display list IDs may be performed by hardware or software. In this embodiment, a newly generated display list ID is managed in a First-In First-Out (FIFO) method, and a display list generated earlier has a higher priority. In addition, in this embodiment, a display list ID is newly generated when a new display list is generated, and the display list ID is deleted when processing on the display list is terminated. Thus, in this embodiment, the display list ID “0” has a higher priority than the display list ID “1”.

After the processing for the command (processing request) received from the image forming unit 100 is terminated, the processor 101 issues to the image forming unit 100 a processing result including the display list ID “0” (12).

When detecting that the processor 101 has issued the processing result to the image forming unit 100, the processor processing termination detector 106 reads the display list ID “0” included in the processing result. The processor processing termination detector 106 issues the read display list ID to the context write-back unit 105 (13).

When receiving the display list ID from the processor processing termination detector 106, the context write-back unit 105 compares the received display list ID with an ID of the display list that is being executed by the image forming unit 100, and determines the priority levels of the display list IDs. Here, since the received display list ID “0” has a priority level higher than that of the display list ID “1” that is being executed by the image forming unit 100, the context write-back unit 105 issues a read instruction signal to the context read unit 104 (14).

When receiving a read instruction signal from the context write-back unit 105, the context read unit 104 issues to the image forming unit 100 a processing stop signal instructing stopping of the processing on the display list ID “1” that is currently being executed (15). In addition, the context read unit 104 issues to the context information holding unit 102 a control signal (CTLA) for storing the context information on the display list ID “1” (16).

Then, after storing of the context information is terminated, the context read unit 104 issues to the image forming unit 100 a processing invalidation signal for the display list that is being executed (17). In addition, the context read unit 104 issues to the context write-back unit 105 a context read termination signal (18). In addition, the context read unit 104 stops issuing a processing stop signal to the image forming unit 100.

When receiving the context read termination signal from the context read unit 104, the context write-back unit 105 issues the display list ID “0” (CTLB) to the context information holding unit 102 (19). In addition, the context write-back unit 105 issues a context write-back instruction signal to the image forming unit 100 (20).

When receiving the context write-back instruction signal from the context write-back unit 105, the image forming unit 100 sets the context information supplied from the context information holding unit 102 (21) inside the image forming unit 100 to continue the processing on the display list ID “0”.

Then, after all the processing on the display list ID “0” is terminated, the image forming unit 100 informs the context write-back unit 105 of deletion of the display list ID “0” (22).

As described above, when the image forming unit 100 issues a processing request to the processor 101 so that processing using a processing function that is not provided in the image forming unit 100 can be performed, the image forming unit 100 switches a context to perform processing on another display list. That is, the image forming unit 100 performs, in parallel with processing by the processor 101, processing on another display list without entering a wait state or stalling. After the processing by the processor 101 is terminated, the image forming unit 100 continues processing on the original display list by switching again to the context in which the processor 101 is requested to perform processing. Thus, the wait time of the image forming unit 100 is reduced, and the throughput is improved.

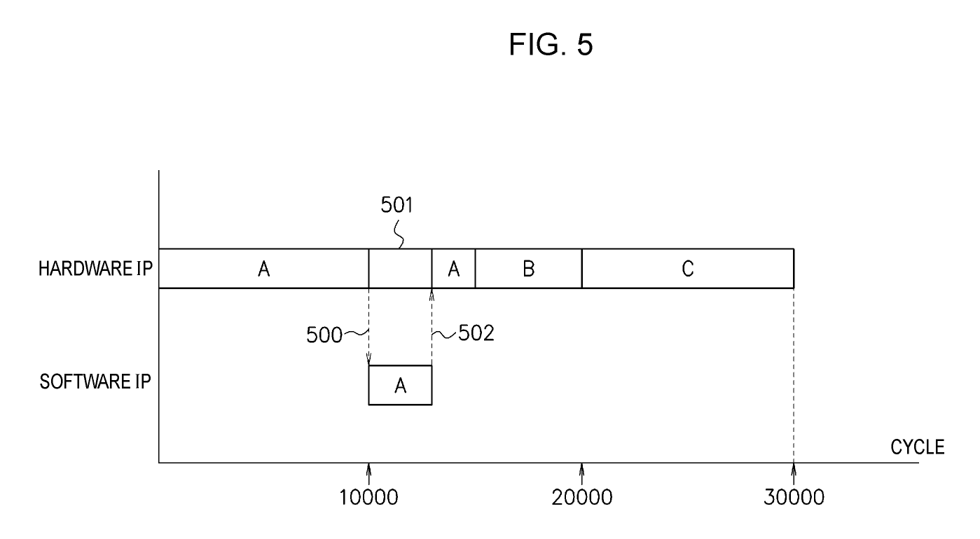

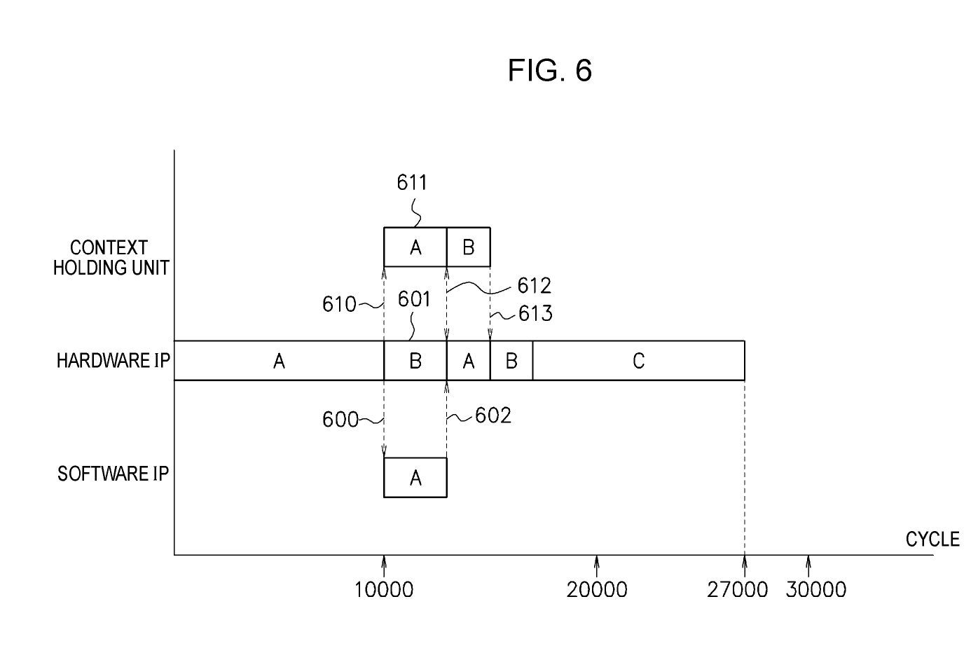

The throughput of the image forming apparatus according to this embodiment is described next with reference to FIGS. 5 and 6. FIG. 5 shows a processing time when the image forming unit 100 does not perform context switch (context switching), and FIG. 6 shows a processing time when the image forming unit 100 performs context switch.

As execution conditions of processing shown in FIGS. 5 and 6, processing on a display list A needs 12000 cycles for processing by the image forming unit 100 and 3000 cycles for processing by the processor 101. In addition, processing on a display list B needs 5000 cycles for processing by the image forming unit 100, and processing on a display list C needs 10000 cycles for processing by the image forming unit 100. Since the time necessary for context switch is much shorter than the time necessary for the processing described above, the time necessary for context switch is omitted in FIG. 6 for the sake of easier explanation.

In FIG. 5, an arrow 500 represents that a processing request is output from the image forming unit 100 to the processor 101 for the display list A, and an arrow 502 represents that a signal indicating termination of the processing is output from the processor 101 to the image forming unit 100. In addition, a section 501 represents that the image forming unit 100 stalls while the processor processing on the display list A is being executed. As shown in FIG. 5, when the image forming unit 100 does not perform context switch, the total processing time required for execution of the processing on the display lists A to C is 30000 cycles.

In FIG. 6, an arrow 600 represents that a processing request is output from the image forming unit 100 to the processor 101 for the display list A, and an arrow 602 represents that a signal indicating termination of the processing is output from the processor 101 to the image forming unit 100. In addition, a section 601 represents that the image forming unit 100 executes processing on the display list B while the processor processing on the display list A is being executed. In addition, an arrow 610 represents reading of a context of the display list A, an arrow 612 represents reading of a context of the display list B and writing back of the context of the display list A, and an arrow 613 represents writing back of the context of the display list B. A section 611 represents that the context of the display list A is saved in the context information holding unit 102 while the image forming unit 100 is executing the processing on the display list B. Thus, as shown in FIG. 6, when the image forming unit 100 performs context switch, the total processing time is reduced to 27000 cycles, which is shorter than the case shown in FIG. 5, thus improving the throughput.

It is noted that the foregoing embodiments are merely examples for carrying out the present invention. Therefore, the technical scope of the present invention should not be restrictively construed by the embodiments. That is, the present invention may be implemented by various other forms without departing from the technical ideas and main features of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-313096 filed Oct. 27, 2005, which is hereby incorporated by reference herein in its entirety.

What is claimed:

1. A data processing apparatus including a logic circuit and a processor, the data processing apparatus comprising:
a holding unit configured to hold task information that is being executed by the logic circuit,
wherein, while executing a first task, the logic circuit requests the processor to execute processing,
wherein the logic circuit executes a second task while the processor is executing the requested processing, and
wherein, after the processor issues a result of the processing, the logic circuit receives from the holding unit task information on the first task and executes the first task.

2. The apparatus according to claim 1, wherein, while the processor is executing the requested processing, the logic circuit interrupts the first task and executes the second task.

3. The apparatus according to claim 1, wherein, after the processor issues the result of the processing, the logic circuit interrupts the second task, receives from the holding unit the task information on the first task, and executes the first task.

4. The apparatus according to claim 3, wherein, after terminating the first task, the logic circuit receives from the holding unit task information on the second task and resumes the second task.

5. The apparatus according to claim 1, wherein the logic circuit has a pipeline structure.

6. The apparatus according to claim 1, wherein the logic circuit executes image forming processing.

7. The apparatus according to claim 1, further comprising a comparing unit configured to compare priority levels of tasks, wherein, when a priority level of the first task is higher than a priority level of the second task, after the processor issues the result of the processing, the logic circuit receives from the holding unit the task information on the first task and executes the first task.

8. A data processing method for use in a logic circuit, the method comprising:
saving task information on a first task when a processor is requested to execute processing while the first task is being executed;
executing a second task while the processor is executing the requested processing; and
restoring the saved task information on the first task in order to execute the first task after the processor issues a result of the processing.

9. The method according to claim 8, wherein while the processor is executing the requested processing, the first task is interrupted, and the second task is executed.

10. The method according to claim 8, wherein after the processor issues the result of the processing, the second task is interrupted, and the saved task information on the first task is restored in order to execute the first task.

11. The method according to claim 10, further comprising:
saving task information on the interrupted second task; and
restoring the saved task information on the second task in order to resume the second task after the first task is terminated.

12. The method according to claim 8, further comprising comparing priority levels of tasks, when a priority level of the first task is higher than a priority level of the second task, after the processor issues the result of the processing, the saved task information on the first task is restored in order to execute the first task.

13. A computer readable medium containing computer-executable instructions for processing data in a logic circuit, the medium comprising:
computer-executable instructions for saving task information on a first task when a processor is requested to execute processing while the first task is being executed;
computer-executable instructions for executing a second task while the processor is executing the requested processing; and
computer-executable instructions for restoring the saved task information on the first task in order to execute the first task after the processor issues a result of the processing.

14. The computer readable medium according to claim 13, wherein while the processor is executing the requested processing, the first task is interrupted, and the second task is executed.

15. The computer readable medium according to claim 13, wherein after the processor issues the result of the processing, the second task is interrupted, and the saved task information on the first task is restored in order to execute the first task.

16. The computer readable medium according to claim 15, further comprising:
computer-executable instructions for saving task information on the interrupted second task; and
computer-executable instructions for restoring the saved task information on the second task in order to resume the second task after the first task is terminated.

17. The computer readable medium according to claim 13, further comprising computer-executable instructions for comparing priority levels of tasks, wherein when a priority level of the first task is higher than a priority level of the second task, after the processor issues the result of the processing, the saved task information on the first task is restored in order to execute the first task.
